(19) United States
(12) Patent Application Publication
(10) Pub. No.: US 2014/0173427 A1
(43) Pub. Date: Jun. 19, 2014

(54) UNDO DELETE METHOD OF TEXT EDITOR SUPPORTING NON-CHARACTER-BASED DELETE FUNCTION IN ELECTRONIC DEVICE AND RELATED MACHINE-READABLE MEDIUM

(71) Applicant: MEDIATEK INC., Hsin-Chu (TW)

(72) Inventor: Hui-Wen Wang, Taipei City (TW)

(73) Assignee: MEDIATEK INC., Hsin-Chu (TW)

(21) Appl. No.: 13/720,954

(22) Filed: Dec. 19, 2012

(51) Int. Cl. G06F 17/24

(52) U.S. Cl. CPC G06F 17/24
USPC 715/256

(57) ABSTRACT

An undo delete method of a text editor supporting a non-character-based delete function in an electronic device includes: performing a non-character-based delete operation to remove a set of text at an original position in a display area of the text editor from the display area; when the non-character-based delete operation terminates, temporarily inserting the set of removed text back in the original position in the display area; checking if a user confirmation is received, and accordingly generating a checking result; and selectively maintaining or removing the set of inserted text according to the checking result.

### BACKGROUND

The disclosed embodiments of the present invention relate to performing an undo delete function, and more particularly, to an undo delete method of a text editor supporting a non-character-based delete function in an electronic device (e.g. a fast delete function in a portable electronic device), and a machine-readable medium thereof.

Undo delete is a basic and yet very useful function for text editing. For a portable electronic device, however, such as a personal digital assistant (PDA), the interface for performing an undo delete has been severely restricted if not omitted entirely due to a lack of comprehensively-designed auxiliary user input devices, such as a physical keyboard or a mouse. Some devices or applications provide a “fast delete” function which is a word-by-word deleting function triggered/activated by pressing and holding a delete button or a backspace button for more than one second. When the fast delete function is activated, it is very likely that a user will delete more text than intended. The user will then have to either retype the over-deleted texts or undo the whole delete operation and re-delete the texts again.

There is a need, therefore, for an innovative undo delete method to provide efficient and precise recovery of unintentionally deleted text when performing the fast delete function in a portable electronic device.

### SUMMARY

In accordance with exemplary embodiments of the present invention, an undo delete method of a text editor supporting a non-character-based delete function in an electronic device (e.g. a fast delete function in a portable electronic device), and a machine-readable medium thereof, are proposed to solve the above-mentioned problem.

According to a first aspect of the present invention, an exemplary undo delete method is disclosed. The undo delete method includes performing a non-character-based delete operation to remove a set of text at an original position in a display area of the text editor from the display area; when the non-character-based delete operation terminates, temporarily inserting the set of removed text back in the original position in the display area; checking if a user confirmation is received, and accordingly generating a checking result; and selectively maintaining or removing the set of inserted text according to the checking result.

According to a second aspect of the present invention, an exemplary non-transitory machine-readable medium storing a program code is provided. When executed by a processor, the program code causes the processor to perform the following steps: performing a non-character-based delete operation to remove a set of text at an original position in a display area of the text editor from the display area; when the non-character-based delete operation terminates, temporarily inserting the set of removed text back in the original position in the display area; checking if a user confirmation is received, and accordingly generating a checking result; and selectively maintaining or removing the set of inserted text according to the checking result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a display area of a text editor according to an embodiment of the present invention.

FIG. 2 is a schematic diagram illustrating the display area of the text editor immediately after performing a non-character-based delete operation according to an embodiment of the present invention.

FIG. 3 is a schematic diagram illustrating the display area of the text editor after temporarily inserting the deleted sub-paragraph according to an embodiment of the present invention.

FIG. 4 is a schematic diagram illustrating the display area of the text editor after undoing the deletion of a sub-paragraph according to an embodiment of the present invention.

FIG. 5 is a flowchart of an undo delete method of the text editor supporting a non-character-based delete function in an electronic device.

FIG. 6 is a block diagram illustrating an undo delete module according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

A concept of the present invention is to recover unintentionally deleted texts when performing a non-character-based delete function (e.g. a fast delete function) in a portable electronic device, such as a personal digital assistant (PDA), a tablet, or a smart-phone. The present invention proposes an additional editing phase automatically inserted after the non-character-based delete operation terminates, in order to provide a quick remedy mechanism for recovering unintentionally deleted texts. Further details are described in the following.

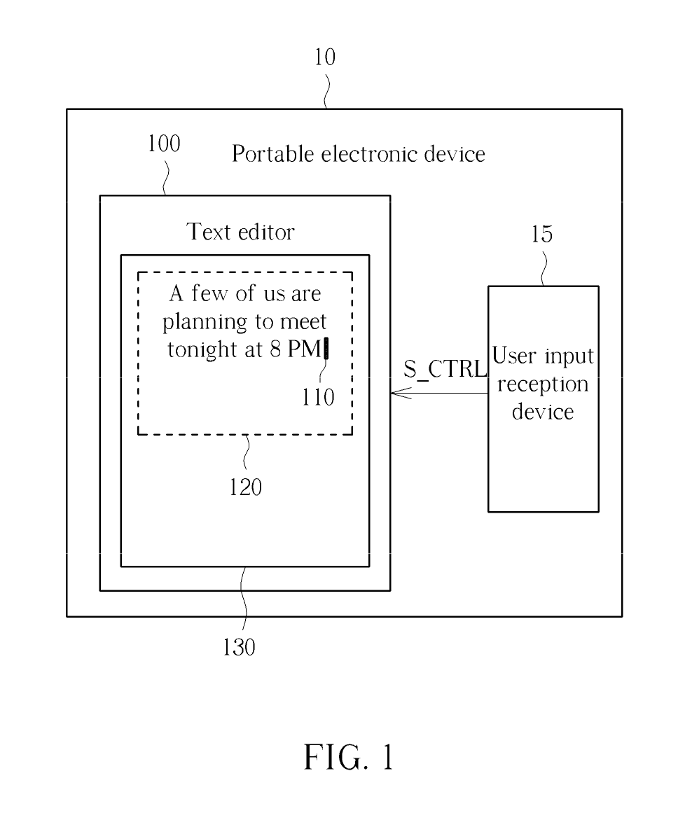

Please refer to FIG. 1, which is a schematic diagram illustrating a display area 130 of a text editor 100 according to an embodiment of the present invention. The text editor 100 supports a non-character-based delete function and is installed/executed in a portable electronic device 10. The portable electronic device 10 may be a personal digital assistant (PDA), a tablet, or a smart-phone, and may include a user input reception device (e.g. a man-machine interface/user interface) 15 for receiving a user input. For example, the input reception device 15 may be a touch-sense panel for receiving a user's touch or a stylus command indicative of a control signal S_CTRL. This is for illustrative purposes only, and not meant to be a limitation of the present invention. The user input reception device 15 may also be either one of, or a combination of: a physical key pad, a button, a selection wheel, a voice control module and/or an optical control module.

In FIG. 1, the display area 130 displays a paragraph of texts 120 and a cursor 110. When the user input reception device 15 receives a user input (e.g. a long press on a delete key or a backspace key) such that the control signal S_CTRL instructs the text editor 100 to perform a non-character-based delete operation on the paragraph of texts 120, the non-character-based delete function of the text editor 100 will be activated and the text editor 100 will start to perform the non-character-based delete operation on the paragraph of texts 120 and erase texts word-by-word starting from the most adjacent word to the left of the cursor 110. Once the non-character-based delete operation starts, the text editor 100 will keep erasing texts from the paragraph of texts 120 until the user input reception device 15 receives another user input (e.g. releasing the delete key or the backspace key).

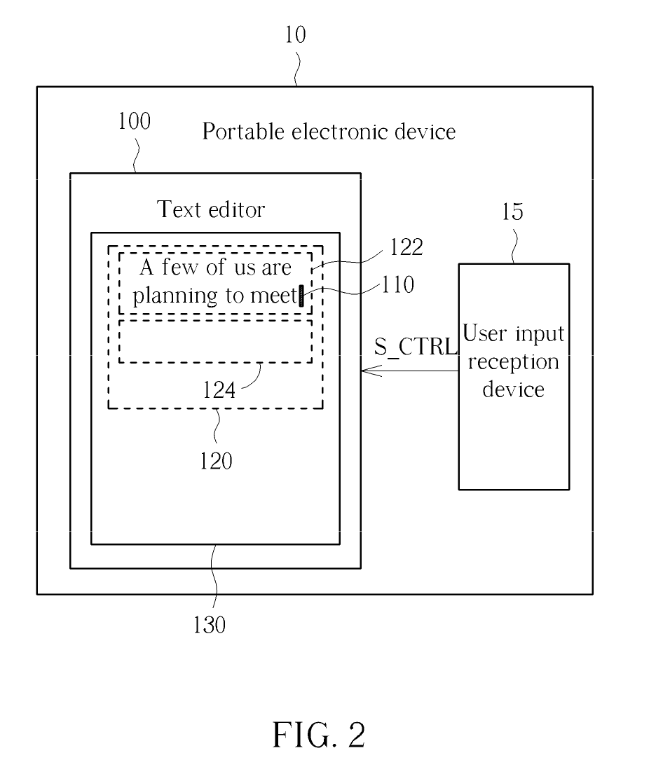

Please refer to FIG. 2, which is a schematic diagram illustrating the display area 130 of the text editor 100 immediately after performing a non-character-based delete operation according to an embodiment of the present invention. 100. In FIG. 2, the paragraph of texts 120 is reduced to a sub-paragraph 122 of the paragraph of texts 120, and the cursor 110 is accordingly moved to the end of the sub-paragraph 122. In other words, a sub-paragraph 124 of the paragraph of texts 120 is removed from the paragraph of texts 120 due to the operation of the non-character-based delete operation.

When the user input reception device 15 receives a user input (e.g. releasing the delete key or the backspace key) such that the control signal S_CTRL instructs the text editor 100 to terminate the non-character-based delete operation, the text editor 100 terminates the non-character-based delete operation. After the text editor 100 terminates the non-character-based delete operation, the text editor 100 will initiate an undo delete phase which includes a series of operations. First, the text editor 100 temporarily inserts the sub-paragraph 124 back in the original position in the display area 130. Then, the text editor 100 displays a user interface (UI) object 140 in the display area 130 to instruct the user to follow through the operations of the undo delete phase.

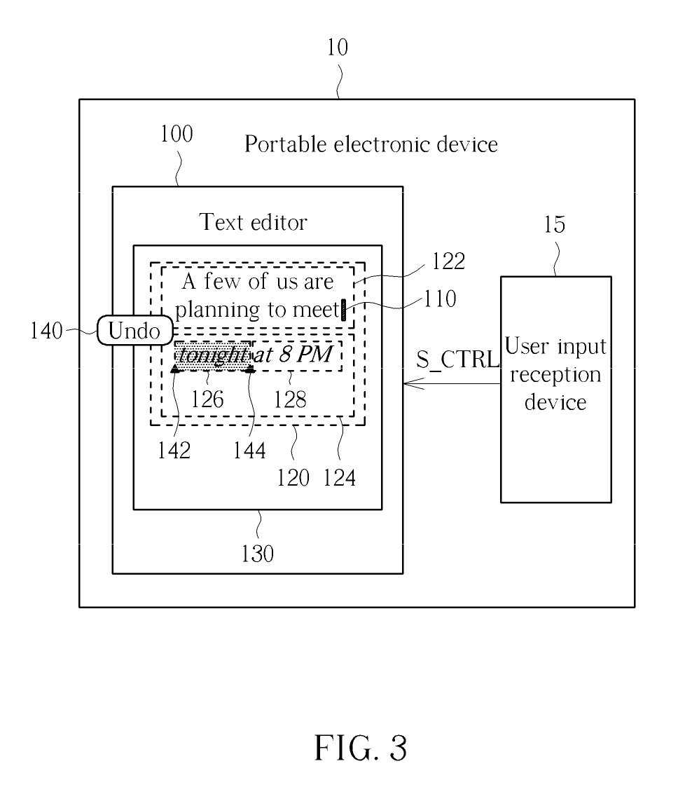

Please refer to FIG. 3, which is a schematic diagram illustrating the display area 130 of the text editor 100 after temporarily inserting the deleted sub-paragraph 124 according to an embodiment of the present invention. In FIG. 3, the sub-paragraph 124 is re-inserted in the display area 130. In addition, the sub-paragraph 124 is adjusted to a low-contrast color in order to be easily distinguished from the sub-paragraph 122.

The first word of the sub-paragraph 124 is highlighted and marked by a start point indicator 142 and an end point indicator 144 of the UI object 140. The start point indicator 142 is first positioned at the beginning of the first word of the sub-paragraph 124 and the end point indicator 144 is first positioned at the end of the first word of the sub-paragraph 124. The start point indicator 142 and the end point indicator 144 are arranged to determine a range of selection that is ready to be recovered. That is, between the start point indicator 142 and the end point indicator 144 is a selected sub-paragraph 126 of the sub-paragraph 124 that will be recovered from the previous non-character-based delete operation, whereas a sub-paragraph 128 of the sub-paragraph 124 is unselected. When the user input reception device 15 receives a user input such that the control signal S_CTRL instructs the text editor 100 to reposition the start point indicator 142 or the end point indicator 144, the text editor 100 alters the range of the sub-paragraph 126 by repositioning the start point indicator 142 or the end point indicator 144 or both. The range of the selected sub-paragraph 126 is highlighted in order to be easily distinguished from the unselected sub-paragraph 128.

In this embodiment, the UI object 140 further includes a function menu containing an undo confirmation button 146. When the undo confirmation button 146 is triggered such that the control signal S_CTRL instructs the text editor 100 to recover the sub-paragraph 126 and discard the sub-paragraph 128, the text editor 100 restores the sub-paragraph 126 back from a non-character-based delete operation, and discards the sub-paragraph 128 for real.

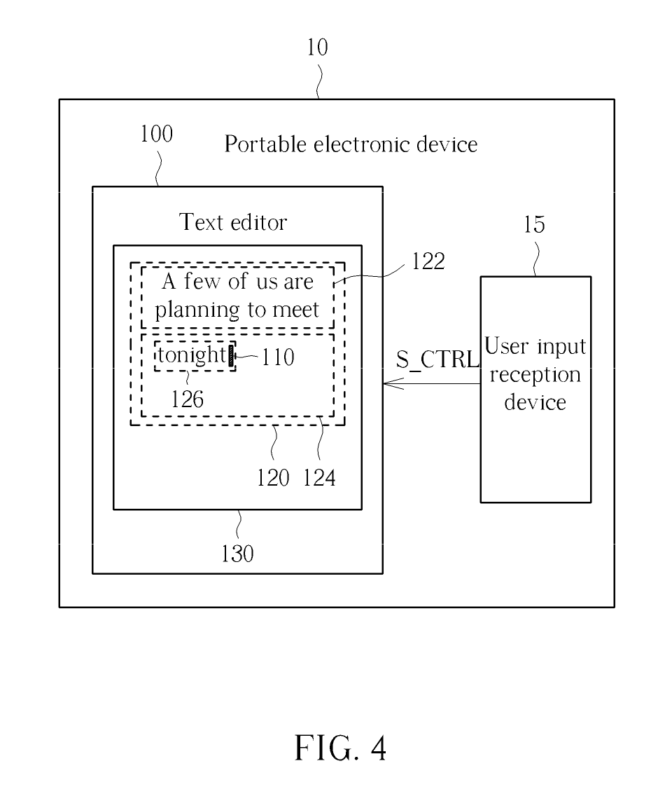

Please refer to FIG. 4, which is a schematic diagram illustrating the display area 130 of the text editor 100 after undoing deletion of the sub-paragraph 126 according to an embodiment of the present invention. In FIG. 4, the paragraph 120 now includes sub-paragraph 122 and sub-paragraph 126, and the cursor 110 is accordingly moved to the end of the sub-paragraph 126.

Please note that, in this embodiment, since the undo delete phase is triggered automatically, it is possible that the sub-paragraph 124 is precisely what the user intends to delete. In a case where a user does not intend to proceed with the undo delete phase after the non-character-based delete operation, the text editor 100 counts a predetermined time period (e.g. one second) from immediately after the non-character-based delete operation terminates, and checks if there is any user input received before the predetermined time period expires. If there is no user input received before the predetermined time period expires, the text editor 100 terminates the undo delete phase and revokes the UI object 140. If there is a user input other than the undo delete confirmation or the altering selection range that is received before the predetermined time period expires, the text editor 100 considers such user input as a confirmation of a non-character-based delete operation, and the text editor 100 terminates the undo delete phase and revokes the UI object 140. This is for illustrative purposes only, and not meant to be a limitation of the present invention.

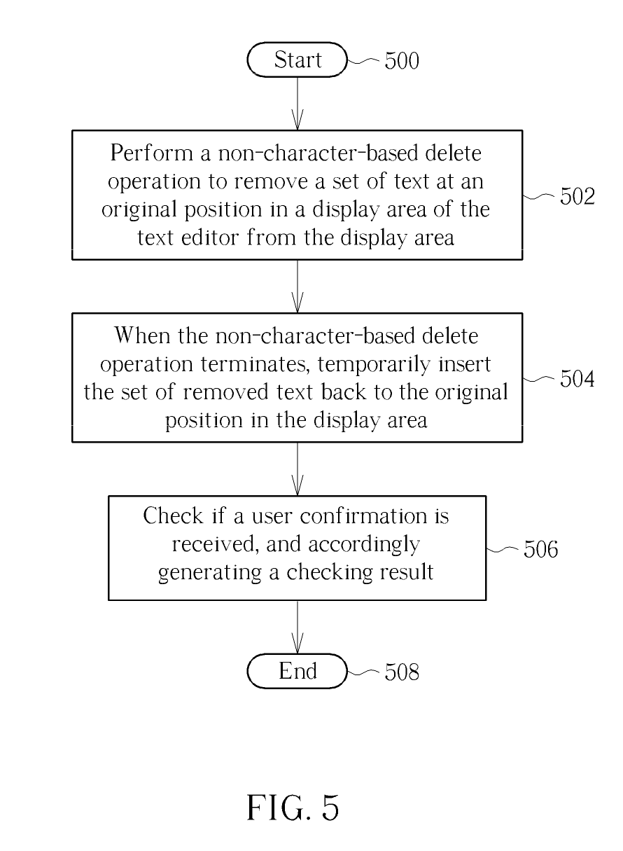

The above operations of the undo delete phase can be summarized into a flowchart. Please refer to FIG. 5, which is a flowchart of an undo delete method of the text editor 100 supporting a non-character-based delete function in an electronic device. Provided that the result is substantially the same, the steps are not required to be executed in the exact order shown in FIG. 5. The exemplary control method may be briefly summarized by the following steps.

Step 500: Start.

Step 502: Perform a non-character-based delete operation to remove a set of text at an original position in a display area of the text editor from the display area.

Step 504: When the non-character-based delete operation terminates, temporarily insert the set of removed text back in the original position in the display area.

Step 506: Check if a user confirmation is received, and accordingly generate a checking result.

Step 508: Selectively maintain or remove the set of inserted text according to the checking result.

As a person skilled in the art can readily understand the operation of each step shown in FIG. 5 after reading the above paragraphs, further description is omitted here for brevity.

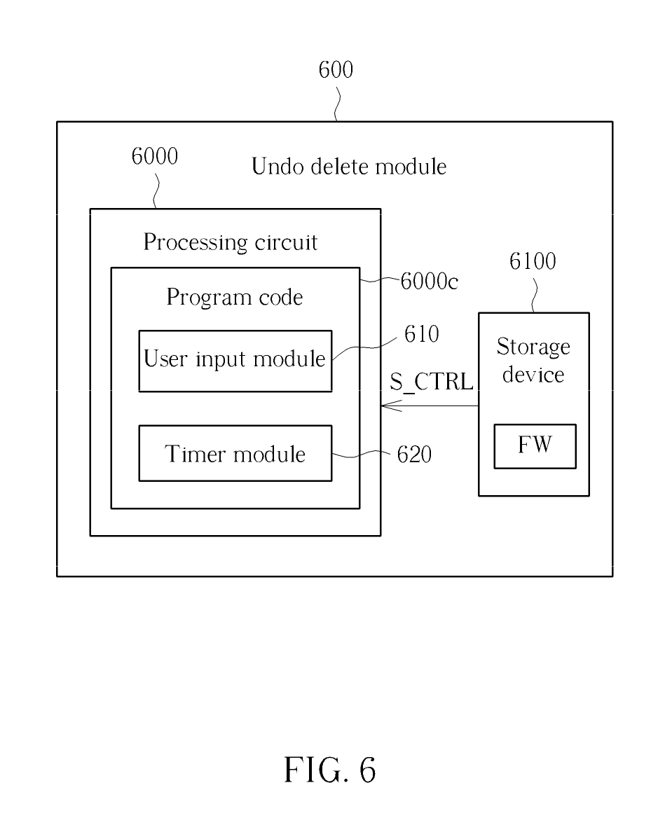

Please refer to FIG. 6, which is a block diagram illustrating an undo delete module 600 according to an embodiment of the present invention. According to this embodiment, the text editor 100 can be implemented by utilizing a processing circuit 6000 executing a program code 6000C. For example, the processing circuit 6000 may be a processor, and the program code 6000C may be firmware FW stored in a machine-readable medium such as a storage device (e.g. a non-volatile memory device) 6100. Hence, when loaded and executed by the processing circuit 6000, the program code 6000C causes the processing circuit 6000 to perform a non-character-based delete operation to remove a set of text at an original position in a display area of the text editor from the display area.

In addition, the program code 6000C may include at least one program module, such as a user input module 610 and a timer module 620, where the user input module 610 can receive a user input indicative of the control signal S_CTRL from a user, and the timer module 620 can count the predetermined time period (e.g. one second) from immediately after the non-character-based delete operation terminates. As a person skilled in the art can readily understand operational details of the user input module 610 and timer module 620 after reading the above paragraphs, similar descriptions are not repeated herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An undo delete method of a text editor supporting a non-character-based delete function in an electronic device, the undo delete method comprising:
performing a non-character-based delete operation to remove a set of text at an original position in a display area of the text editor from the display area;
when the non-character-based delete operation terminates, temporarily inserting the set of removed text back in the original position in the display area;
checking if a user confirmation is received, and accordingly generating a checking result; and
selectively maintaining or removing the set of inserted text according to the checking result.

2. The undo delete method of claim 1, further comprising:
counting a predetermined time period from when the non-character-based delete operation terminates;
and the step of checking if the user confirmation is received, and accordingly generating a checking result comprises:
when a first user input indicative of an undo delete confirmation is received before the predetermined time period expires, generating the checking result to instruct maintaining of a selected part of the set of temporarily inserted text, and removing the non-selected part of the set of temporarily inserted text;
when a second user input indicative of a delete confirmation is received before the predetermined time period expires, generating the checking result to instruct removing the set of temporarily inserted text; and
when neither the first user input nor a second user input indicative of a delete confirmation is received during the predetermined time period, generating the checking result to instruct removing of the set of temporarily inserted text.

3. The undo delete method of claim 2, wherein the step of checking if the user confirmation is received further comprises:
showing a user interface (UI) object in the display area, wherein the first user input is generated when the UI object is triggered, and the second user input is a user input which is not generated due to triggering the UI object.

4. The undo delete method of claim 3, wherein the selected part of the set of temporarily inserted text is selected via the user interface object.

5. The undo delete method of claim 2, wherein the step of temporarily inserting the set of removed text further comprises:
setting a start point indicator of the selected part of the set of temporarily inserted text at the beginning of the first word of the set of temporarily inserted text;
setting an end point indicator of the selected part of the set of temporarily inserted text at the end of the first word of the set of temporarily inserted text; and
selectively altering a range of the selected part of the set of temporarily inserted text.

6. The undo delete method of claim 5, wherein the step of selectively altering the range of the set of temporarily inserted text comprises:
altering the range of the selected part of the set of temporarily inserted text by repositioning the end point indicator and the start point.

7. The undo delete method of claim 5, wherein the step of selectively altering the range of the set of temporarily inserted text comprises:
altering the range of the selected part of the set of temporarily inserted text by repositioning the end point indicator.

8. The undo delete method of claim 5, wherein the step of temporarily inserting the set of removed text comprises:
highlighting the range of the selected part of the set of temporarily inserted text.

9. The undo delete method of claim 1, wherein the electronic device is a portable electronic device.

10. A non-transitory machine-readable medium storing a program code that, when executed by a processor, causes the processor to perform the following steps:
performing a non-character-based delete operation to remove a set of text at an original position in a display area of the text editor from the display area;
when the non-character-based delete operation terminates, temporarily inserting the set of removed text back in the original position in the display area;
checking if a user confirmation is received, and accordingly generating a checking result; and
selectively maintaining or removing the set of inserted text according to the checking result.

11. The non-transitory machine-readable medium of claim 10, wherein the program code, when executed by the processor, further causes the processor to perform the following step:
counting a predetermined time period from when the non-character-based delete operation terminates;
and the step of checking if the user confirmation is received, and accordingly generating a checking result comprises:
when a first user input indicative of an undo delete confirmation is received before the predetermined time period expires, generating the checking result to instruct maintaining of a selected part of the set of temporarily inserted text, and removing the non-selected part of the set of temporarily inserted text;
when a second user input indicative of a delete confirmation is received before the predetermined time period expires, generating the checking result to instruct removing the set of temporarily inserted text; and
when neither the first user input nor a second user input indicative of a delete confirmation is received during the predetermined time period, generating the checking result to instruct removing of the set of temporarily inserted text.

12. The non-transitory machine-readable medium of claim 11, wherein the step of checking if the user confirmation is received further comprises:
showing a user interface (UI) object in the display area, wherein the first user input is generated when the UI object is triggered, and the second user input is a user input which is not generated due to triggering the UI object.

13. The non-transitory machine-readable medium of claim 12, wherein the selected part of the set of temporarily inserted text is selected via the user interface object.

14. The non-transitory machine-readable medium of claim 11, wherein the step of temporarily inserting the set of removed text further comprises:
setting a start point indicator of the selected part of the set of temporarily inserted text at the beginning of the first word of the set of temporarily inserted text;
setting an end point indicator of the selected part of the set of temporarily inserted text at the end of the first word of the set of temporarily inserted text; and
selectively altering a range of the selected part of the set of temporarily inserted text.

15. The non-transitory machine-readable medium of claim 14, wherein the step of selectively altering the range of the set of temporarily inserted text comprises:
altering the range of the selected part of the set of temporarily inserted text by repositioning the end point indicator and the start point.

16. The non-transitory machine-readable medium of claim 14, wherein the step of selectively altering the range of the set of temporarily inserted text comprises:
altering the range of the selected part of the set of temporarily inserted text by repositioning the end point indicator.

17. The non-transitory machine-readable medium of claim 14, wherein the step of temporarily inserting the set of removed text comprises:
highlighting the range of the selected part of the set of temporarily inserted text.
